(19) United States
(12) Patent Application Publication
(10) Pub. No.: US 2021/0258961 A1
(43) Pub. Date: Aug. 19, 2021

(54) DATA TRANSMISSION METHOD AND DEVICE

(71) Applicant: Guangdong Oppo Mobile Telecommunications Corp., Ltd., Dongguan (CN)

(72) Inventors: Zhenshan Zhao, Dongguan (CN); Qianxi Lu, Dongguan (CN); Huei-Ming Lin, Victoria (AU)

(21) Appl. No.: 17/313,820

(22) Filed: May 6, 2021

Related U.S. Application Data
(63) Continuation of application No. PCT/CN2018/120297, filed on Dec. 11, 2018.

(51) Int. Cl. H04W 72/04; H04W 4/40

(52) U.S. Cl. CPC H04W 72/0486; H04W 92/18; H04W 4/40

(57) ABSTRACT

Disclosed is a data transmission method, comprising: a first terminal device determines a data transmission mode, the data transmission mode comprising a data transmission mode based on transport blocks or a data transmission mode based on a code block group; and the first terminal device transmits data according to the data transmission mode. Therefore, in communication between terminal devices, whether to perform data transmission on the basis of transport blocks or data block groups can be selected according to actual situations, thereby reducing the resource overhead of data transmission, especially during data retransmission, and improving data transmission efficiency.

### CROSS-REFERENCE TO RELATED APPLICATION

This application is a continuation application of PCT Patent Application No. PCT/CN2018/120297, entitled “DATA TRANSMISSION METHOD AND DEVICE” filed on Dec. 11, 2018, the disclosure of which is incorporated herein by reference in its entirety.

### TECHNICAL FIELD

The embodiments of the present application relate to the field of communications, and more particularly, to a data transmission method and device.

### BACKGROUND

Vehicle to Everything (V2X) communication is a Sidelink (SL) transmission technology based on Device to Device (D2D) communication. Different from the traditional Long Term Evolution (LTE) system in which data is sent or received through a base station, the V2X system adopts terminal-to-terminal direct communication, and thus has higher spectrum efficiency and lower transmission delay.

In the V2X communication of a 5G, i.e., New Radio (NR) system (NR-V2X), in order to support higher data throughput, a size of a transport block can be up to 10,000 bytes. In order to transmit such a large transport block, the corresponding resource overhead increases, and when an error occurs in the transmission of the transport block and retransmission is required, the resource overhead will multiply.

### SUMMARY

Embodiments of the present application provide a data transmission method and device.

In a first aspect, a data transmission method is provided, including: determining, by a first terminal device, a data transmission scheme, the data transmission scheme including a transport block based data transmission scheme or a code block group based data transmission scheme; and sending data by the first terminal device according to the data transmission scheme.

In a second aspect, a data transmission method is provided, including: determining, by a second terminal device, a data transmission scheme, the data transmission scheme including a transport block based data transmission scheme or a code block group based data transmission scheme; and receiving data by the second terminal device according to the data transmission scheme.

In a third aspect, a terminal device is provided, and the terminal device can perform the method in the foregoing first aspect or any optional implementation of the first aspect. Specifically, the terminal device can include functional modules for performing the method in the foregoing first aspect or any possible implementation of the first aspect.

In a fourth aspect, a terminal device is provided, and the terminal device can perform the method in the foregoing second aspect or any optional implementation of the second aspect. Specifically, the terminal device can include functional modules for performing the method in the foregoing second aspect or any possible implementation of the second aspect.

In a fifth aspect, there is provided a terminal device including a processor and a memory. The memory is used for storing a computer program, and the processor is configured to call and run the computer program stored in the memory to perform the method in the foregoing first aspect or any possible implementation of the first aspect.

In a sixth aspect, there is provided a terminal device including a processor and a memory. The memory is used for storing a computer program, and the processor is configured to call and run the computer program stored in the memory to perform the method in the foregoing second aspect or any possible implementation of the second aspect.

In a seventh aspect, a chip is provided to implement the method in the foregoing first aspect or any possible implementation of the first aspect. Specifically, the chip includes a processor, configured to call and run a computer program from a memory to cause a device installed with the chip to perform the method in the foregoing first aspect or any possible implementation of the first aspect.

In an eighth aspect, a chip is provided to implement the method in the foregoing second aspect or any possible implementation of the second aspect. Specifically, the chip includes a processor, configured to call and run a computer program from a memory to cause a device installed with the chip to perform the method in the foregoing second aspect or any possible implementation of the second aspect.

In a ninth aspect, a computer-readable storage medium is provided for storing a computer program that causes a computer to perform the method in the foregoing first aspect or any possible implementation of the first aspect.

In a tenth aspect, a computer-readable storage medium is provided for storing a computer program that causes a computer to perform the method in the above-mentioned second aspect or any possible implementation of the second aspect.

In an eleventh aspect, a computer program product is provided, including computer program instructions that cause a computer to perform the method in the foregoing first aspect or any possible implementation of the first aspect.

In an twelfth aspect, a computer program product is provided, including computer program instructions that cause a computer to perform the method in the foregoing second aspect or any possible implementation of the second aspect.

In a thirteenth aspect, a computer program is provided, which when running on a computer, causes the computer to perform the method in the foregoing first aspect or any possible implementation of the first aspect.

In a fourteenth aspect, a computer program is provided, which when running on a computer, causes the computer to perform the method in the foregoing second aspect or any possible implementation of the second aspect.

In a fifteenth aspect, a communication system is provided, including a first terminal device and a second terminal device.

Wherein, the first terminal device is configured to determine a data transmission scheme, the data transmission scheme including a transport block based data transmission scheme or a code block group based data transmission scheme; and to send data according to the data transmission scheme.

Wherein, the second terminal device is configured to determine the data transmission scheme, the data transmission scheme including the transport block based data transmission scheme or the code block group based data transmission scheme; and to receive data according to the data transmission scheme.

### BRIEF DESCRIPTION OF THE DRAWINGS

FIG. 1 is a schematic architecture diagram of an application scenario of an embodiment of the present application.

FIG. 2 is a schematic architecture diagram of another application scenario of an embodiment of the present application.

FIG. 3 is a flow interaction diagram of a data transmission method according to an embodiment of the present application.

FIG. 4 is a schematic block diagram of a first terminal device according to an embodiment of the present application.

FIG. 5 is a schematic block diagram of a second terminal device according to an embodiment of the present application.

FIG. 6 is a schematic structural diagram of a terminal device according to an embodiment of the present application.

FIG. 7 is a schematic structural diagram of a chip according to an embodiment of the present application.

FIG. 8 is a schematic block diagram of a communication system according to an embodiment of the present application.

### DETAILED DESCRIPTION

The technical solutions in the embodiments of the present application will be described below in conjunction with the accompanying drawings.

It should be understood that the technical solutions of the embodiments of the present application can be applied to various communication systems, such as a Global System of Mobile Communication (GSM) system, a Code Division Multiple Access (CDMA) system, and a Wideband Code Division Multiple Access (WCDMA) system, a Long Term Evolution (LTE) system, a LTE Frequency Division Duplex (FDD) system, a LTE Time Division Duplex (TDD) system, a Universal Mobile Telecommunication System (UMTS), future 5G communication systems, etc.

Various embodiments are described in connection with the terminal device in the present application. The terminal device may refer to user equipment (UE), an access terminal, a user unit, a user station, a mobile station, a mobile console, a remote station, a remote terminal, a mobile device, a user terminal, a terminal, a wireless communication device, a user agent or a user device. The access terminal can be a cellular phone, a cordless phone, a Session Initiation Protocol (SIP) phone, a Wireless Local Loop (WLL) station, a personal digital assistant (PDA), and wireless communication functional handheld devices, computing devices or other processing devices connected to wireless modems, in-vehicle devices, wearable devices, terminal devices in the future 5G network or future evolution of the Public Land Mobile Network (PLMN), etc.

Various embodiments are described in conjunction with a network device in the present application. The network device can be a device used to communicate with terminal devices, for example, it can be a Base Transceiver Station (BTS) in a GSM system or a CDMA system, or a NodeB (NB) in a WCDMA system, or it can be an Evolutional Node B (eNB or eNodeB) in a LTE system, or the network device can be a relay station, an access point, an in-vehicle device, a wearable device, a network side device in the future 5G network or future evolutional PLMN network, or the like.

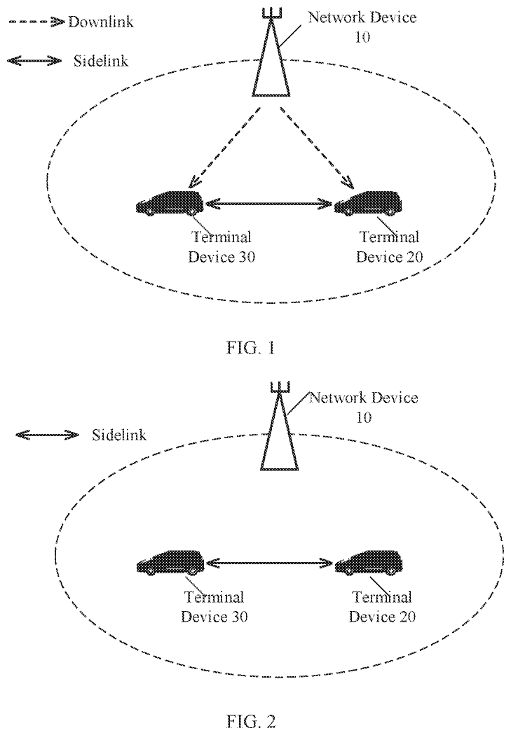

FIG. 1 and FIG. 2 are schematic diagrams of possible application scenarios of embodiments of the present application. FIG. 1 exemplarily shows one network device and two terminal devices. In some embodiments, the wireless communication system can include a plurality of network devices and other numbers of terminal devices can be included in the coverage of each network device, which is not particularly limited in the embodiments of the present disclosure.

In addition, the wireless communication system may also include other network entities such as a Mobile Management Entity (MME), a Serving Gateway (S-GW), a Packet Data Network Gateway (P-GW), etc., which are not limited thereto in the embodiments of the present application.

A terminal device 20 and a terminal device 30 can perform D2D communication, and when performing the D2D communication, the terminal device 20 and the terminal device 30 directly communicate with each other through a D2D link, that is, a sidelink (SL). For example, as shown in FIG. 1 or FIG. 2, the terminal device 20 and the terminal device 30 directly communicate with each other through the sidelink. In FIG. 1, the terminal device 20 and the terminal device 30 communicate through the sidelink, and the transmission resources thereof are assigned by a network device. In FIG. 2, the terminal device 20 and the terminal device 30 communicate through the sidelink, and the transmission resources thereof are independently selected by the terminal devices without assignment of the transmission resources by the network device.

The D2D communication can refer to Vehicle to Vehicle (V2V) communication or Vehicle to Everything (V2X) communication. In V2X communication, X can generally stand for any device with wireless receiving and transmitting capabilities, such as, but is not limited to, a slowly-moving wireless apparatus, a fast-moving in-vehicle device, or a network control node with wireless transmitting and receiving capabilities. It should be understood that the embodiments of the present application are mainly applied to V2X communication scenarios, but can also be applied to any other D2D communication scenario, which is not limited in the embodiments of the present application.

In 3GPP Release-14 (Rel-14), two transmission modes are defined, Mode 3 and Mode 4. In Mode 3, the transmission resources for the terminal device are assigned by the base station, and the terminal device can perform data transmission on the sidelink according to the resources assigned by the base station. The base station can assign resources for a single transmission to the terminal device, or can assign resources for semi-persistent transmission to the terminal device. In Mode 4, if the terminal device has the sensing capability, it adopts a sensing and reservation method to transmit data, and if the terminal device does not have the sensing capability, it randomly selects the transmission resources from a resource pool. The terminal device with the sensing capability obtains a set of available resources from the resource pool by sensing, and randomly selects a resource from the set for data transmission. Because services in the V2X system have periodic characteristics, the terminal device usually adopts the semi-persistent transmission method, that is, after selecting a transmission resource, the terminal can continuously use this resource in multiple transmission cycles so as to reduce a probability of resource re-selection and of resource conflicts. The terminal will carry, in control information of the current transmission, information for reserving the resource for a next transmission, so that other terminal devices can determine whether such resource is reserved and used by the terminal device by detecting the control information of the terminal device, so as to achieve the purpose of reducing the resource conflicts.

In 3GPP Release-16 (Rel-16), multiple transmission modes are introduced, such as Mode 1 and Mode 2. In Mode 1, the terminal device performs data transmission using the transmission resources assigned thereto by the network device (similar to Mode 3 in Rel-14), and in Mode 2, the terminal device select by itself transmission resources for data transmission. Mode 2 can also be divided into several sub-modes, such as Mode 2a, Mode 2b, Mode 2c, and Mode 2d.

In Mode 2a, the terminal device can autonomously select resources for data transmission. For example, the terminal device can autonomously select the resources from a resource pool that is pre-configured or is configured by the network device by way of random selection or resource sensing.

In Mode 2b, the terminal device can assist other terminal devices to select resources. For example, the terminal device sends auxiliary information to other terminal devices, which carries information of available time-frequency resources, information of available transmission resource sets, channel measurement information, and channel quality information such as channel state information (CSI), a Channel Quality Indicator (CQI), a Precoding Matrix Indicator (PMI), Rank Indication (RI), Reference Signal Receiving Power (RSRP), Reference Signal Receiving Quality (RSRQ), a Received Signal Strength Indicator (RSSI), path loss information, etc.

In Mode 2c, the terminal device can select resources from the transmission resources configured therefor. For example, the network device configures corresponding transmission resources for each terminal, and when the terminal device has sidelink data to be transmitted, it performs data transmission using the transmission resources configured therefor by the network device.

In mode 2d, the terminal device can assign transmission resources to other terminal devices. For example, the terminal device may be a group head in a group communication, and the terminal device can assign time-frequency resources for sidelink transmission to members of the group.

In NR-V2X, in order to support higher data throughput, a size of a transport block can be very large. In order to transmit data of a large transport block, the corresponding resource overhead will increase, and when the data of the transport block has an error during the transmission and needs to be retransmitted, the resource overhead will multiply.

In order to reduce the resource overhead of the data transmission between the terminal devices and improve the efficiency of the data transmission, a data transmission method is proposed according to an embodiment of the present application, which is described below with reference to the accompanying drawings.

It should be understood that “pre-configured” mentioned in the embodiments of the present application refers to being agreed in advance, such as prescribed by a protocol, or it can be said to be pre-defined or pre-stored. The “xxx configured by the network device” refers to xxx that is determined and indicated to the terminal device by the network device, or it can be said as xxx configured for the terminal device by the network device.

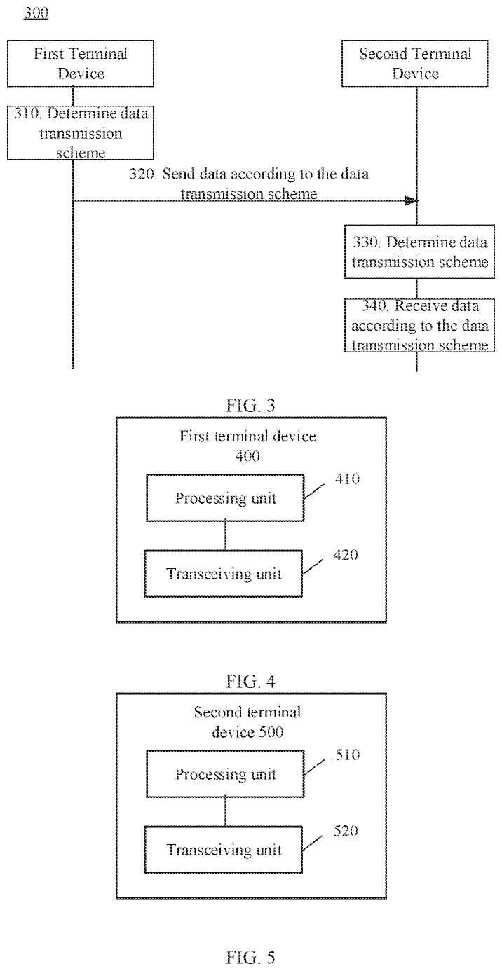

FIG. 3 is a flow interaction diagram of a data transmission method according to an embodiment of the present application. The method shown in FIG. 3 can be performed by a first terminal device and a second terminal device. The first terminal device can be, for example, the terminal device 20 or the terminal device 30 shown in FIG. 1 or FIG. 2, and the second terminal device can be, for example, the terminal device 30 or the terminal device 20 shown in FIG. 1 or FIG. 2. As shown in FIG. 3, the data transmission method includes some or all of the following steps.

In 310, a first terminal device determines a data transmission scheme.

The data transmission scheme includes a transport block based data transmission scheme or a code block group based data transmission scheme.

In 320, the first terminal device sends data to a second terminal device according to the data transmission scheme.

In 330, the second terminal device determines the data transmission scheme.

The data transmission scheme includes the transport block based data transmission scheme or the code block group based data transmission scheme.

In 340, the second terminal device receives, according to the data transmission scheme, the data sent by the first terminal device.

Since the first terminal device and the second terminal device, when performing data transmission therebetween, can select, according to actual situations, an appropriate data transmission scheme, that is, the data transmission scheme based on the transport block or the data transmission scheme based on the code block group, the resource overhead can be reduced in the data transmission, especially the data retransmission, of the terminal device, improving the data transmission efficiency.

The transport block (TB) based data transmission scheme refers to data transmission with granularity of the transport block, where the terminal device transmits one transport block at a time. The code block group based data transmission scheme refers to the data transmission with the granularity of the code block group, where the terminal device can transmit all or part of code block groups of one transport block at a time.

For example, when an amount of data is small, the transport block based data transmission scheme can be used. At this time, the first terminal device sends data of a transport block to the second terminal device. When the data of the transport block has a transmission error and needs to be retransmitted, the first terminal device retransmits the data of the transport block to the second terminal device.

For another example, when the amount of data is large, the code block group based data transmission scheme can be used. At this time, the first terminal device sends data of a transport block to the second terminal device. When the data of part of code block groups in the transport block has a transmission error and needs to be retransmitted, the second terminal device can report to the first terminal device the code block groups that need to be retransmitted, and the first terminal device can retransmit only the data of those code block groups with the error to the second terminal device without retransmitting the data of the entire transport block, thereby greatly reducing the resource overhead.

It is first described below how the first terminal device sends data according to the transport block based data transmission scheme or the code block group based data transmission scheme.

In some embodiments, before 320, the method further includes obtaining first indication information by the first terminal device, where the first indication information is used to indicate a maximum number of code block groups included in the transport block.

In some embodiments, in 310, determining the data transmission scheme by the first terminal device includes determining the data transmission scheme by the first terminal device according to the first indication information.

For example, if the maximum number of the code block groups indicated by the first indication information is equal to 1, the first terminal device determines that the data transmission scheme is the transport block based data transmission scheme; and/or if the maximum number of the code block groups indicated by the first indication information is greater than 1, the first terminal device determines that the data transmission scheme is the code block group based data transmission scheme.

The first terminal device can obtain the first indication information in the following three manners.

Manner 1

In some embodiments, obtaining the first indication information by the first terminal device includes receiving a first sidelink channel by the first terminal device, where the first sidelink channel carries the first indication information.

The first sidelink channel may include any one of the following channels, for example:

a Physical Sidelink Control Channel (PSCCH), for example, the first indication information may be carried in Sidelink Control Information (SCI) in the first sidelink channel;

a Physical Sidelink Shared Channel (PSSCH); and

a Physical Sidelink Broadcast Channel (PSBCH).

For example, the first sidelink channel may be a first sidelink channel sent by the second terminal device. The first terminal device performs unicast communication with the second terminal device, and the second terminal device instructs the first terminal device to use the code block group based data transmission scheme or the transport block based data transmission scheme to perform the data transmission.

For another example, the first sidelink channel may also come from a third terminal device, where the first terminal device, the second terminal device, and the third terminal device form a communication group, and the third terminal device is a group header of the group. The third terminal device can configure the code block group based data transmission scheme or the transport block based data transmission scheme for the communication within the group, and the first terminal device can use the corresponding transmission scheme to transmit data according to the configured information of the third terminal device.

Manner 2

In some embodiments, obtaining the first indication information by the first terminal device includes receiving, by the first terminal device, the first indication information sent by a network device.

The first indication information may be carried in, for example, Radio Resource Control (RRC) signaling, Media Access Control (MAC) signaling, a broadcast message, or Downlink control information (DCI).

Manner 3

In some embodiments, obtaining the first indication information by the first terminal device includes obtaining pre-configured first indication information by the first terminal device.

The number of code blocks included in each code block group can be determined in the following manner, for example. By dividing a total number C of code blocks included in one transport block by the maximum number N of the code block groups, the number M of code blocks included in each code block group is obtained. For example, when C=8 and N=4, the transport block includes 4 code block groups, and each code block group includes 2 code blocks; and when C=2 and N=4, the transport block includes 2 code block groups, and each code block group includes 1 code block.

When the terminal device knows the maximum number of the code block groups included in the transport block, it can determine the data transmission scheme to be used according to the maximum number of the code block groups included in the transport block.

The terminal device may determine the data transmission scheme according to the above first indication information, or may determine the data transmission scheme according to second indication information.

In some embodiments, the method further includes obtaining second indication information by the first terminal device, where the second indication information is used to indicate the data transmission scheme.

In some embodiments, in 310, determining the data transmission scheme by the first terminal device includes determining the data transmission scheme by the first terminal device according to the second indication information.

The first terminal device can obtain the second indication information in the following four manners.

Manner 1

The second indication information is carried in the first sidelink channel mentioned above.

For example, both the second indication information and the first indication information are carried in the SCI of the first sidelink channel.

Manner 2

In some embodiments, obtaining the second indication information by the first terminal device includes receiving a second sidelink channel by the first terminal device, where the second sidelink channel carries the second indication information.

The second sidelink channel may be a PSCCH, a PSSCH or a PSBCH, for example.

The first indication information is, for example, carried in the SCI of the second sidelink channel.

For example, the second sidelink channel may be a second sidelink channel sent by the second terminal device. The first terminal device performs unicast communication with the second terminal device, and the second terminal device instructs the first terminal device to use the code block group based data transmission scheme or the transport block based data transmission scheme to perform the data transmission.

For another example, the second sidelink channel may also come from a third terminal device, where the first terminal device, the second terminal device, and the third terminal device form a communication group, and the third terminal device is a group header of the group. The third terminal device can configure the code block group based data transmission scheme or the transport block based data transmission scheme for the communication within the group, and the first terminal device can use the corresponding transmission scheme to transmit data according to the configured information of the third terminal device.

Manner 3

In some embodiments, obtaining the second indication information by the first terminal device includes receiving, by the first terminal device, the second indication information sent by the network device.

The second indication information may be carried in, for example, RRC signaling. MAC signaling, a broadcast message, or DCI.

Manner 4

In some embodiments, obtaining the second indication information by the first terminal device includes obtaining pre-configured second indication information by the first terminal device.

The first terminal device obtains the pre-stored second indication information, so as to determine the maximum number of the code block groups included in the transport block.

The terminal device may determine the data transmission scheme to be used according to the second indication information, and obtain the maximum number of the code block groups included in the transport block according to the first indication information, so as to perform data transmission based on the transport block.

In some embodiments, the method further includes sending third indication information by the first terminal device, where the third indication information is used to indicate information of the code block groups in the current transmission.

For example, the third indication information includes a bitmap including a plurality of bits, the plurality of bits respectively correspond to a plurality of code block groups in the transport block, and a value of each bit is used to indicate whether the data currently transmitted includes the data of the code block group corresponding to the bit.

When the data is transmitted for the first time, that is, initially transmitted, the third indication information indicates information of all code block groups, for example, all the bits of the bitmap are set to 1, indicating that the data of all the code block groups are included in data currently transmitted; and when the data is retransmitted, the third indication information indicates information of the retransmitted code block groups, for example, the data includes 4 code block groups and the first and third code block groups need to be transmitted in the retransmission, the bits of the bitmap are set to 1010, corresponding to the first to fourth code block groups from left to right, indicating that the data currently transmitted includes only the data of the first and third code block groups.

For another example, the third indication information may include index information of one or more code block groups, and the index information of each code block group uniquely identifies the code block group. The index information included in the third indication information is used to indicate that the data currently transmitted includes the data of the code block group corresponding to the index information.

When the data is transmitted for the first time, that is, initially transmitted, the third indication information indicates information of all the code block groups, for example, the third indication information includes the index information of all the code block groups, indicating that the data currently transmitted includes the data of all the code block groups; and when the data is retransmitted, the third indication information indicates the information of the code block groups that are retransmitted. For example, the data includes 4 code block groups and the second and fourth code block groups need to be transmitted in the retransmission, the third indication information includes the index information of the second and fourth code block groups, indicating that the data currently transmitted includes only the data of the second and fourth code block groups.

In some embodiments, sending the third indication information by the first terminal device includes sending a third sidelink channel by the first terminal device, where the third sidelink channel carries the third indication information.

The third sidelink channel may be a PSCCH, a PSSCH or a PSBCH, for example.

In some embodiments, the third indication information may also implicitly indicate the maximum number of the code block groups and/or the data transmission scheme.

For example, assuming that the bitmap includes N bits, which correspond to N code block groups in one transport block, if the value of the bit corresponding to the i-th code block group is 1, it indicates that the data currently transmitted includes the data of the i-th code block group, and if the value of the bit corresponding to the i-th code block group is 0, it indicates that the data of the i-th code block group is not included in the data currently transmitted, where i ranges from 1 to N.

In some embodiments, the number N of the bits in the bitmap may be used to indicate the maximum number of the code block groups. And further, the maximum number of the code block groups can be used to indicate the data transmission scheme. For example, if the maximum number of the code block groups is equal to 1, it indicates to receive data based on the transport block; and if the maximum number of code block groups is greater than 1, it indicates to receive data based on the code block group.

When the third indication information can indicate the maximum number of the code block groups of one transport block, the first terminal device may not send the first indication information; or when the third indication information can indicate the data transmission scheme, the first terminal device may not send the first indication information or the second indication information.

In some embodiments, the third indication information carries Hybrid Automatic Repeat Request (HARQ) process information, for example, the HARQ process information corresponding to the data that is currently retransmitted.

Next, it will be described how the second terminal device receives data correspondingly according to the transport block based data transmission scheme or the code block group based data transmission scheme.

In some embodiments, before 340, the method further includes obtaining first indication information by the second terminal device, where the first indication information is used to indicate a maximum number of code block groups included in a transport block.

In some embodiments, obtaining the first indication information by the second terminal device includes receiving a first sidelink channel by the first terminal device, where the first sidelink channel carries the first indication information.

In some embodiments, the first sidelink channel includes any one of the following channels: a PSCCH, a PSSCH, and a PSBCH.

In some embodiments, obtaining the first indication information by the second terminal device includes receiving, by the second terminal device, the first indication information sent by the network device.

In some embodiments, the first indication information is carried in radio resource control (RRC) signaling, medium access control (MAC) signaling, a broadcast message, or downlink control information (DCI).

In some embodiments, obtaining the first indication information by the second terminal device includes obtaining pre-configured first indication information by the second terminal device.

In some embodiments, in 330, determining the data transmission scheme by the second terminal device includes determining the data transmission scheme by the second terminal device according to the first indication information.

For example, determining the data transmission scheme by the second terminal device according to the first indication information includes that if the maximum number of the code block groups indicated by the first indication information is equal to 1, the second terminal device determines that the data transmission scheme is the transport block based data transmission scheme; and/or if the maximum number of the code block groups indicated by the first indication information is greater than 1, the second terminal device determines that the data transmission scheme is the code block group based data transmission scheme.

In some embodiments, the method further includes obtaining second indication information by the second terminal device, where the second indication information is used to indicate the data transmission scheme.

In 330, determining the data transmission scheme by the second terminal device includes determining the data transmission scheme by the second terminal device according to the second indication information.

In some embodiments, the second indication information is carried in the first sidelink channel.

In some embodiments, obtaining the second indication information by the second terminal device includes receiving a second sidelink channel by the second terminal device, where the second sidelink channel carries the second indication information.

In some embodiments, the second sidelink channel includes any one of the following channels: a PSCCH, a PSSCH, and a PSBCH.

In some embodiments, obtaining the second indication information by the second terminal device includes receiving, by the second terminal device, the second indication information sent by the network device.

In some embodiments, the second indication information is carried in RRC signaling, MAC signaling, a broadcast message or DCI.

In some embodiments, obtaining the second indication information by the second terminal device includes obtaining pre-configured second indication information by the second terminal device.

In some embodiments, the method further includes obtaining third indication information by the second terminal device, where the third indication information is used to indicate information of the code block groups currently transmitted.

In some embodiments, obtaining the third indication information by the second terminal device includes receiving a third sidelink channel by the second terminal device, where the third sidelink channel carries the third indication information.

In some embodiments, the third sidelink channel includes any one of the following channels: a PSCCH, a PSSCH, and a PSBCH.

For example, the third indication information includes a bitmap including a plurality of bits, the plurality of bits respectively correspond to a plurality of code block groups in the transport block, and a value of each bit is used to indicate whether the data currently transmitted includes the data of the code block group corresponding to the bit.

When the data is transmitted for the first time, that is, initially transmitted, the third indication information indicates information of all code block groups, for example, all the bits of the bitmap are set to 1, indicating that the data of all the code block groups are included in data currently transmitted; and when the data is retransmitted, the third indication information indicates information of the retransmitted code block groups. For example, the data includes 4 code block groups and the first and third code block groups need to be transmitted in the retransmission, the bits of the bitmap are set to 1010, corresponding to the first to fourth code block groups from left to right, indicating that the data currently transmitted includes only the data of the first and third code block groups.

For another example, the third indication information may include index information of one or more code block groups, and the index information of each code block group uniquely identifies the code block group. The index information included in the third indication information is used to indicate that the data currently transmitted includes the data of the code block group corresponding to the index information.

When the data is transmitted for the first time, that is, initially transmitted, the third indication information indicates information of all the code block groups, for example, the third indication information includes the index information of all the code block groups, indicating that the data currently transmitted includes the data of all the code block groups; and when the data is retransmitted, the third indication information indicates the information of the code block groups that are retransmitted. For example, when the data includes 4 code block groups and the second and fourth code block groups need to be transmitted in the retransmission, the third indication information includes the index information of the second and fourth code block groups, indicating that the data currently transmitted includes only the data of the second and fourth code block groups.

In some embodiments, the third indication information may also be used to indicate the maximum number of the code block groups and/or the data transmission scheme.

In some embodiments, in 330, determining the data transmission scheme by the second terminal device includes determining the data transmission scheme by the second terminal device according to the third indication information.

In some embodiments, the method further includes: determining the maximum number of the code block groups by the second terminal device according to the third indication information. For example, the second terminal device may determine the maximum number of the code block groups according to the number of bits included in the bitmap.

For example, assuming that the bitmap includes N bits, which correspond to N code block groups in one transport block, if the value of the bit corresponding to the i-th code block group is 1, it indicates that the data currently transmitted includes the data of the i-th code block group, and if the value of the bit corresponding to the i-th code block group is 0, it indicates that the data of the i-th code block group is not included in the data currently transmitted, where i ranges from 1 to N.

In some embodiments, the second terminal device may also determine the maximum number of the code block groups according to the number N of the bits in the bitmap. And further, the second terminal device can also determine the data transmission scheme according to the maximum number of the code block groups. For example, if the maximum number of the code block groups is equal to 1, the data is received based on the transport block, and if the maximum number of the code block groups is greater than 1, the data is received based on the code block group.

When the third indication information can indicate the maximum number of the code block groups of one transport block, the second terminal device may not receive the first indication information; or when the third indication information can indicate the data transmission scheme, the second terminal device may not receive the first indication information or the second indication information.

In some embodiments, the third indication information carries HARQ process information.

It should be understood that for the specific process for the second terminal device to receive data according to the determined data transmission scheme, reference can be made to the aforementioned process for the first terminal device to send data according to the corresponding data transmission scheme, which will not be repeated here for the sake of brevity.

It should be noted that under the premise of no conflict, various embodiments and/or the technical features in the embodiments described in this application can be combined with each other arbitrarily, and the technical solutions obtained from the combination should also fall within the protection scope of this application.

It should be understood that in the embodiments of the present application, the sequence numbers of the above-mentioned process do not mean the performing order, and the performing order of the process should be determined according to the functions and the internal logic thereof, and should not be limited in the implementations of the embodiments of the present application.

The communication method according to the embodiments of the present application has been described above in detail. A device according to the embodiments of the present application will be described below in conjunction with FIG. 4 to FIG. 8. The technical features described in the method embodiments are applicable to the following device embodiments.

FIG. 4 is a schematic block diagram of a terminal device 400 according to an embodiment of the present application. The terminal device is applied to D2D communication, and the terminal device is the first terminal device. As shown in FIG. 4, the first terminal device 400 includes a processing unit 410 and a transceiving unit 420.

The processing unit 410 is configured to determine a data transmission scheme, where the data transmission scheme includes a transport block based data transmission scheme or a code block group based data transmission scheme.

The transceiver unit 420 is configured to send data according to the data transmission scheme determined by the processing unit 410.

Therefore, the terminal devices, when performing communication therebetween, can choose whether to perform data transmission based on the transport block or based on the code block group depending on actual situations, thereby reducing the resource overhead of the data transmission, especially of the data retransmission, and improving data transmission efficiency.

In some embodiments, the processing unit 410 is further configured to obtain first indication information, where the first indication information is used to indicate a maximum number of code block groups included in the transport block.

In some embodiments, the processing unit 410 is specifically configured to: control the transceiver unit 420 to receive a first sidelink channel, where the first sidelink channel carries the first indication information.

In some embodiments, the first sidelink channel includes any one of the following channels: a PSCCH, a PSSCH, and a PSBCH.

In some embodiments, the processing unit 410 is specifically configured to: control the transceiving unit 420 to receive the first indication information sent by a network device.

In some embodiments, the first indication information is carried in RRC signaling, MAC signaling, a broadcast message or DCI.

In some embodiments, the processing unit 410 is specifically configured to obtain the first indication information that is pre-configured.

In some embodiments, the processing unit 410 is specifically configured to determine the data transmission scheme according to the first indication information.

In some embodiments, the processing unit 410 is specifically configured to determine that the data transmission scheme is the transport block based data transmission scheme if the maximum number of the code block groups indicated by the first indication information is equal to 1; and/or determine that the data transmission scheme is the code block group based data transmission scheme if the maximum number of the code block groups indicated by the first indication information is greater than 1.

In some embodiments, the processing unit 410 is specifically configured to: obtain second indication information, where the second indication information is used to indicate the data transmission scheme; and determine the data transmission scheme according to the second indication information.

In some embodiments, the second indication information is carried in the first sidelink channel.

In some embodiments, the processing unit 410 is specifically configured to control the transceiver unit 420 to receive a second sidelink channel, where the second sidelink channel carries the second indication information.

In some embodiments, the second sidelink channel includes any one of the following channels: a PSCCH, a PSSCH, and a PSBCH.

In some embodiments, the processing unit 410 is specifically configured to control the transceiving unit 420 to receive the second indication information sent by the network device.

In some embodiments, the second indication information is carried in RRC signaling, MAC signaling, a broadcast message or DCI.

In some embodiments, the processing unit 410 is specifically configured to obtain the second indication information that is pre-configured.

In some embodiments, the transceiving unit 420 is further configured to send third indication information, where the third indication information is used to indicate information of the code block groups that are currently transmitted.

In some embodiments, the transceiving unit 420 is specifically configured to send a third sidelink channel, where the third sidelink channel carries the third indication information.

In some embodiments, the third indication information includes a bitmap including a plurality of bits, the plurality of bits respectively correspond to a plurality of code block groups in the transport block, and a value of each bit is used to indicate whether the data currently transmitted includes the data of the code block group corresponding to the bit.

In some embodiments, the third sidelink channel includes any one of the following channels: a PSCCH, a PSSCH, and a PSBCH.

In some embodiments, the third indication information carries HARQ process information.

It should be understood that the terminal device 400 can perform the corresponding operations performed by the first terminal device in the foregoing method 300, which will not be repeated here for the sake of brevity.

FIG. 5 is a schematic block diagram of a terminal device 500 according to an embodiment of the present application. The terminal device is applied to device-to-device (D2D) communication, and the terminal device is the second terminal device. As shown in FIG. 5, the second terminal device 500 includes a processing unit 510 and a transceiver unit 520.

The processing unit 510 is configured to determine a data transmission scheme, where the data transmission scheme includes a transport block based data transmission scheme or a code block group based data transmission scheme.

The transceiver unit 520 is configured to receive data according to the data transmission scheme determined by the processing unit 510.

Therefore, the terminal devices, when performing communication therebetween, can choose whether to perform data transmission based on the transport block or based on the code block group depending on the actual situations, thereby reducing the resource overhead of the data transmission, especially of the data retransmission, and improving data transmission efficiency.

In some embodiments, the processing unit 510 is further configured to obtain first indication information, where the first indication information is used to indicate a maximum number of code block groups included in the transport block.

In some embodiments, the processing unit 510 is specifically configured to: control the transceiver unit 520 to receive a first sidelink channel, w % here the first sidelink channel carries the first indication information.

In some embodiments, the first sidelink channel includes any one of the following channels: a PSCCH, a PSSCH, and a PSBCH.

In some embodiments, the processing unit 510 is specifically configured to control the transceiving unit 520 to receive the first indication information sent by a network device.

In some embodiments, the first indication information is carried in RRC signaling, MAC signaling, a broadcast message or DC1.

In some embodiments, the processing unit 510 is specifically configured to obtain the first indication information that is pre-configured.

In some embodiments, the processing unit 510 is specifically configured to determine the data transmission scheme according to the first indication information.

In some embodiments, the processing unit 510 is specifically configured to determine that the data transmission scheme is the transport block based data transmission scheme if the maximum number of the code block groups indicated by the first indication information is equal to 1; and/or determine that the data transmission scheme is the code block group based data transmission scheme if the maximum number of the code block groups indicated by the first indication information is greater than 1.

In some embodiments, the processing unit 510 is specifically configured to obtain second indication information, where the second indication information is used to indicate the data transmission scheme; and determine the data transmission scheme according to the second indication information.

In some embodiments, the second indication information is carried in the first sidelink channel.

In some embodiments, the processing unit 510 is specifically configured to control the transceiver unit 520 to receive a second sidelink channel, where the second sidelink channel carries the second indication information.

In some embodiments, the second sidelink channel includes any one of the following channels: a PSCCH, a PSSCH, and a PSBCH.

In some embodiments, the processing unit 510 is specifically configured to control the transceiving unit 520 to receive the second indication information sent by the network device.

In some embodiments, the second indication information is carried in RRC signaling, MAC signaling, a broadcast message or DCI.

In some embodiments, the processing unit 510 is specifically configured to obtain the second indication information that is pre-configured.

In some embodiments, the transceiving unit 520 is further configured to receive third indication information, where the third indication information is used to indicate information of the code block groups that are currently transmitted.

In some embodiments, the transceiving unit 520 is specifically configured to receive a third sidelink channel, where the third sidelink channel carries the third indication information.

In some embodiments, the third sidelink channel includes any one of the following channels: a PSCCH, a PSSCH, and a PSBCH.

In some embodiments, the processing unit 510 is specifically configured to determine the data transmission scheme according to the third indication information.

In some embodiments, the processing unit 510 is further configured to determine the maximum number of the code block groups according to the third indication information.

In some embodiments, the third indication information includes a bitmap including a plurality of bits, the plurality of bits respectively correspond to a plurality of code block groups in the transport block, and a value of each bit is used to indicate whether the data currently transmitted includes the data of the code block group corresponding to the bit.

In some embodiments, the third indication information carries Hybrid Automatic Repeat Request (HARQ) process information.

It should be understood that the terminal device 500 can perform the corresponding operations performed by the second terminal device in the foregoing method 300, which will not be repeated here for the sake of brevity.

FIG. 6 is a schematic structural diagram of a terminal device 600 according to an embodiment of the present application. The terminal device 600 shown in FIG. 6 includes a processor 610. The processor 610 can call and run a computer program from a memory to implement the methods according to the embodiments of the present application.

In some embodiments, as shown in FIG. 6, the terminal device 600 can further include a memory 620. The processor 610 can call and run the computer program from the memory 620 to implement the methods according to the embodiments of the present application.

The memory 620 can be a separate device independent of the processor 610, or can be integrated in the processor 610.

In some embodiments, as shown in FIG. 6, the terminal device 600 can further include a transceiver 630, and the processor 610 can control the transceiver 630 to communicate with other devices, and specifically, it can transmit information or data to other devices, or receive information or data transmitted from other devices.

The transceiver 630 can include a transmitter and a receiver. The transceiver 630 can further include an antenna, and the number of the antennas can be one or more.

In some embodiments, the terminal device 600 can specifically be the first terminal device in the embodiments of the present application, and the terminal device 600 can implement the corresponding process that is implemented by the first terminal device in the methods according to the embodiments of the present application, which will not be repeated here for the sake of brevity.

In some embodiments, the terminal device 600 can specifically be the second terminal device in the embodiments of the present application, and the terminal device 600 can implement the corresponding process that is implemented by the second terminal device in the methods according to the embodiments of the present application, which will not be repeated here for the sake of brevity.

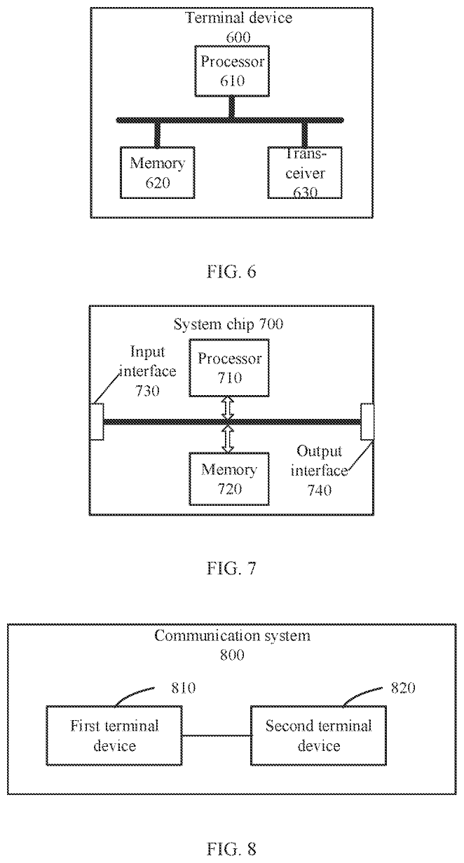

FIG. 7 is a schematic structural diagram of a chip according to an embodiment of the present application. The chip 700 shown in FIG. 7 includes a processor 710 which can call and run a computer program from a memory to implement the methods according to the embodiments of the present application.

In some embodiments, as shown in FIG. 7, the chip 700 can further include a memory 720. The processor 710 can call and run the computer program from the memory 720 to implement the methods according to the embodiments of the present application.

The memory 720 can be a separate device independent of the processor 710, or can be integrated in the processor 710.

In some embodiments, the chip 700 can further include an input interface 730. The processor 710 can control the input interface 730 to communicate with other devices or chips, and specifically, to obtain information or data transmitted by other devices or chips.

In some embodiments, the chip 700 can further include an output interface 740. The processor 710 can control the output interface 740 to communicate with other devices or chips, and specifically, to output information or data to other devices or chips.

In some embodiments, the chip can be applied to the first terminal device in the embodiments of the present application, and the chip can implement the corresponding process which is implemented by the first terminal device in the methods according to the embodiments of the present application, which will not be repeated here for the sake of brevity.

In some embodiments, the chip can be applied to the second terminal device in the embodiments of the present application, and the chip can implement the corresponding process which is implemented by the second terminal device in the methods according to the embodiments of the present application, which will not be repeated here for the sake of brevity.

It should be understood that the chip mentioned in the embodiments of the present application can also be referred to as a system-level chip, a system chip, a chip system, or a system-on-chip.

It should be understood that the processor according to the embodiments of the present application can be an integrated circuit chip with signal processing capability. In the implementations, the steps of the foregoing method embodiments can be performed by an integrated logic circuit of hardware in the processor or by instructions in a form of software. The foregoing processor can be a general-purpose processor, a Digital Signal Processor (DSP), an Application Specific Integrated Circuit (ASIC), a Field Programmable Gate Array (FPGA), other programmable logic devices, discrete gate or transistor logic device, or a discrete hardware component, which can implement the methods, steps, and logical blocks disclosed in the embodiments of the present disclosure. The general-purpose processor can be a microprocessor, any conventional processor or the like. The steps of the methods disclosed in connection with the embodiments of the present disclosure can be directly embodied in and performed by a hardware decoding processor, or can be implemented by a combination of hardware and software modules in the decoding processor. The software modules can be located in a mature storage medium in the art such as a random access memory, a flash memory, a read-only memory, a programmable read-only memory, an electrically erasable programmable memory or a register. The storage medium is located in the memory, and the processor reads information in the memory and implements the steps of the above methods in combination with the hardware thereof.

It can be understood that the memory in the embodiments of the present application may be a volatile memory or a non-volatile memory, or may include both the volatile and non-volatile memories. In an embodiment, the non-volatile memory can be a Read-Only Memory (ROM), a Programmable ROM (PROM), an erasable PROM (EPROM), an electrically EPROM (EEPROM) or a flash memory. The volatile memory may be a Random Access Memory (RAM), which is used as an external cache. By way of exemplary but not restrictive description, many forms of RAMs are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM)) and a Direct Rambus RAM (DR RAM). It should be noted that the memories of the systems and methods described herein are intended to include, but are not limited to, these and any other suitable types of memories.

It should be understood that the foregoing description of the memory is exemplary rather than limiting. For example, the memory in the embodiments of the present disclosure can also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch-Link DRAM (SLDRAM), a Direct Rambus RAM (DR RAM), among others. That is to say, the memory in the embodiments of the present disclosure is intended to include but is not limited to those and any other suitable types of memories.

FIG. 8 is a schematic block diagram of a communication system 800 according to an embodiment of the present application. As shown in FIG. 8, the communication system 800 includes a first terminal device 810 and a second terminal device 820.

The first terminal device 810 is configured to determine a data transmission scheme, where the data transmission scheme includes a transport block based data transmission scheme or a code block group based data transmission scheme; and to send data according to the data transmission scheme.

The second terminal device 820 is configured to determine the data transmission scheme, where the data transmission scheme includes the transport block based data transmission scheme or the code block group based data transmission scheme; and to receive data according to the data transmission scheme.

The terminal device 810 can be used to implement the corresponding functions implemented by the first terminal device in the above method 300, and the composition of the first terminal device 810 can be as shown in the first terminal device 400 in FIG. 4, which will not be repeated here for the sake of brevity.

The second terminal device 820 can be used to implement the corresponding functions implemented by the second terminal device in the above method 300, and the composition of the second terminal device 820 can be as shown in the second terminal device 500 in FIG. 5, which will not be repeated here for the sake of brevity.

The embodiments of the present application also provide a computer readable storage medium for storing a computer program. In some embodiments, the computer readable storage medium may be applied to the first terminal device in the embodiments of the present application, and the computer program causes a computer to perform the corresponding process implemented by the first terminal device in the methods according to the embodiments of the present application, which will not be repeated here for the sake of brevity. In some embodiments, the computer readable storage medium may be applied to the second terminal device in the embodiments of the present application, and the computer program causes the computer to perform the corresponding process implemented by the second terminal device in the methods according to the embodiments of the present application, which will not be repeated here for the sake of brevity.

The embodiments of the present application also provide a computer program product, including computer program instructions. In some embodiments, the computer program product can be applied to the first terminal device in the embodiments of the present application, and the computer program instructions cause a computer to perform the corresponding process implemented by the first terminal device in the methods according to the embodiments of the present application, which will not be repeated here for the sake of brevity. In some embodiments, the computer program product can be applied to the second terminal device in the embodiments of the present application, and the computer program instructions cause the computer to perform the corresponding process implemented by the second terminal device in the methods according to the embodiments of the present application, which will not be repeated here for the sake of brevity.

The embodiments of the present application also provide a computer program. In some embodiments, the computer program can be applied to the first terminal device in the embodiments of the present application. When running on a computer, the computer program causes the computer to perform the corresponding process implemented by the first terminal device in the methods according to the embodiments of the present application, which will not be repeated here for the sake of brevity. In some embodiments, the computer program can be applied to the second terminal device in the embodiments of the present application. When running on a computer, the computer program causes the computer to perform the corresponding process implemented by the second terminal device in the methods according to the embodiments of the present application, which will not be repeated here for the sake of brevity.

It should be understood that the terms “system” and “network” are often used interchangeably herein. The term “and/or” used herein is merely to describe relative relationships of relative objects, indicating that there can be three kinds of relationships. For example, A and/or B can indicate three cases where A exists alone, A and B exist simultaneously, or B exists alone. In addition, the character “/” used herein generally indicates that the related objects before and after this character are in an “or” relationship.

It should also be understood that, in the embodiments of the present invention, “A corresponding to B” means that A is associated with B, and A can be determined from B. However, it should also be understood that determining A from B does not mean that A is determined only from B. and A can also be determined from B and/or other information.

Those of ordinary skill in the art can recognize that the exemplary units and algorithm steps described in connection with the embodiments disclosed herein can be implemented in electronic hardware or a combination of computer software and the electronic hardware. Whether these functions are implemented in hardware or in software depends on the specific applications of the technical solutions and design constraints. Various methods can be used by professional technicians to implement the described functions for each specific application, and such implementations should not be considered as going beyond the scope of the present application.

Those skilled in the art can clearly understand that for convenience and conciseness of the description, for the specific operating process of the systems, devices and units described above, reference can be made to corresponding process in the foregoing method embodiments, which will not be repeated here.

According to the embodiments provided in the present application, it should be understood that the systems, devices, and methods disclosed can be implemented in other manners. For example, the device embodiments described above are merely illustrative. For example, division of the units is only a logical function division, and in actual implementations, there can be other division manners. For example, a plurality of units or components can be combined or integrated into another system, or some features can be ignored or not implemented. In addition, the coupling or direct coupling or communication connection shown or discussed herein can also be indirect coupling or communication connection through some interfaces, devices or units, and can be in electrical, mechanical or other forms.

The units described as separate components may be or may not be physically separated, and the components shown as units may be or may not be physical units, that is, they may be located in one place or may be distributed on multiple network units. Some or all of the units can be selected to achieve the objectives of the solutions of the embodiments according to actual requirements.

In addition, the functional units in the embodiments of the present disclosure can be integrated into one processing unit, or each unit can individually exist physically, or two or more of the units can be integrated into one unit.

If implemented in the form of software functional units and sold or used as an independent product, the functions can be stored in a computer-readable storage medium. Based on such understanding, the technical solution of the present disclosure essentially, a part thereof that contributes to the prior art, or a part of the technical solution can be embodied in the form of a software product, and the computer software product is stored in a storage medium and includes instructions which cause a computer device (which may be a personal computer, a server, a network device or the like) to perform all or part of the steps of the methods described in the embodiments of the present disclosure. The foregoing storage medium includes various medium such as a USB drive, a removable hard disk, a ROM, a RAM, a magnetic disk or an optical disc that can store program codes.

Those described above are only specific implementations of the present application, and the protection scope of the present application is not limited thereto. Any alteration or replacement readily devised by a person skilled in the art within the technical scope disclosed in the present disclosure shall fall within the scope of the present application. Therefore, the protection scope of the present application shall be subject to the protection scope of the claims.

What is claimed is:

1. A data transmission method that is applied to device-to-device (D2D) communication, the method comprising:
determining, by a first terminal device, a data transmission scheme, the data transmission scheme comprising a transport block based data transmission scheme or a code block group based data transmission scheme, and
sending data by the first terminal device according to the data transmission scheme.

2. The method according to claim 1, further comprising:
obtaining, by the first terminal device, first indication information, the first indication information being used to indicate a maximum number of code block groups included in a transport block.

3. The method according to claim 2, wherein the obtaining, by the first terminal device, the first indication information comprises:
receiving, by the first terminal device, a first sidelink channel, the first sidelink channel carrying the first indication information.

4. The method according to claim 2, wherein the obtaining, by the first terminal device, the first indication information comprises:
receiving, by the first terminal device, the first indication information sent by a network device.

5. The method according to claim 2, wherein the determining, by the first terminal device, the data transmission scheme comprises:
determining, by the first terminal device, that the data transmission scheme is the transport block based data transmission scheme when the maximum number of the code block groups indicated by the first indication information is equal to 1; and/or
determining, by the first terminal device, that the data transmission scheme is the code block group based data transmission scheme when the maximum number of the code block groups indicated by the first indication information is greater than 1.

6. The method according to claim 1, further comprising:
obtaining, by the first terminal device, second indication information, the second indication information being used to indicate the data transmission scheme,
wherein the determining, by the first terminal device, the data transmission scheme comprises:
determining, by the first terminal device according to the second indication information, the data transmission scheme.

7. The method according to claim 6, wherein the obtaining, by the first terminal device, the second indication information comprises:
receiving, by the first terminal device, a second sidelink channel, the second sidelink channel carrying the second indication information.

8. The method according to claim 6, wherein the obtaining, by the first terminal device, the second indication information comprises:
receiving, by the first terminal device, the second indication information sent by a network device.

9. The method according to claim 1, further comprising:
sending, by the first terminal device, third indication information, the third indication information being used to indicate information of the code block groups that are currently transmitted.

10. The method according to claim 9, wherein the third indication information comprises a bitmap comprising a plurality of bits, the plurality of bits respectively correspond to a plurality of code block groups in the transport block, and a value of each bit is used to indicate whether data that is currently transmitted comprises the data of the code block group corresponding to the bit.

11. A data transmission method that is applied to device-to-device (D2D) communication, the method comprising:
determining, by a second terminal device, a data transmission scheme, the data transmission scheme comprising a transport block based data transmission scheme or a code block group based data transmission scheme; and
receiving data by the second terminal device according to the data transmission scheme.

12. The method according to claim 11, further comprising
obtaining, by the second terminal device, first indication information, the first indication information being used to indicate a maximum number of code block groups included in a transport block.

13. The method according to claim 12, wherein the obtaining, by the second terminal device, the first indication information comprises:
receiving, by the second terminal device, a first sidelink channel, the first sidelink channel carrying the first indication information.

14. The method according to claim 12, wherein the obtaining, by the second terminal device, the first indication information comprises:
receiving, by the second terminal device, the first indication information sent by a network device.

15. The method according to claim 12, wherein the determining, by the second terminal device, the data transmission scheme comprises:
determining, by the second terminal device, that the data transmission scheme is the transport block based data transmission scheme when the maximum number of the code block groups indicated by the first indication information is equal to 1; and/or
determining, by the second terminal device, that the data transmission scheme is the code block group based data transmission scheme when the maximum number of the code block groups indicated by the first indication information is greater than 1.

16. The method according to claim 11, further comprising:
obtaining, by the second terminal device, second indication information, the second indication information being used to indicate the data transmission scheme,
wherein the determining, by the second terminal device, the data transmission scheme comprises:
determining, by the second terminal device according to the second indication information, the data transmission scheme.

17. The method according to claim 16, wherein the obtaining, by the second terminal device, the second indication information comprises;
receiving, by the second terminal device, a second sidelink channel, the second sidelink channel carrying the second indication information.

18. The method according to claim 16, wherein the obtaining, by the second terminal device, the second indication information comprises:
receiving, by the second terminal device, the second indication information sent by a network device.

19. The method according to claim 11, further comprising:
receiving, by the second terminal device, third indication information, the third indication information being used to indicate information of the code block groups that are currently transmitted.

20. A terminal device that is applied to device-to-device (D2D) communication, wherein the terminal device is a first terminal device, and the first terminal device comprises:
a memory;
a processor configured to determine a data transmission scheme, the data transmission scheme comprising a transport block based data transmission scheme or a code block group based data transmission scheme; and
a transceiver configured to send data according to the data transmission scheme determined by the processor.
